(19) United States
(12) Patent Application Publication
(10) Pub. No.: US 2025/0234237 A1
(43) Pub. Date: Jul. 17, 2025

(54) ECENTRAL UNIT, DISTRIBUTED UNIT, USER EQUIPMENT AND METHOD FOR APPLICATION DATA UNIT BASED DATA TRANSMISSION

(71) Applicant: Lenovo (Beijing) Limited, Beijing (CN)

(72) Inventors: Mingzeng Dai, Shanghai (CN); Haiyan Luo, Shangai (CN); Congchi Zhang, Shanghai (CN); Yibin Zhuo, Beijing (CN); Le Yan, Shanghai (CN)

(73) Assignee: Lenovo (Beijing) Limited, Beijing (CN)

(21) Appl. No.: 18/833,333

(22) PCT Filed: Jan. 26, 2022
(86) PCT No.: PCT/CN2022/074036

§ 371 Date: Jul. 25, 2024

(51) Int. Cl. H04W 28/02; H04L 47/32; H04W 92/12

(52) U.S. Cl. CPC H04W 28/0252; H04L 47/32; H04W 92/12

(57) ABSTRACT

The present application relates to a CU, a DU, a UE and a method for ADU based data transmission. The CU: receives ADU information related to a plurality of ADUs from a CN; determine DRB and ADU association information related to one or more of the plurality of ADUs that are associated with one or more DRBs to the DU of the network node over a CU-DU interface; and transmit the DRB and ADU association information and the ADU information to the DU over the CU-DU interface.

### TECHNICAL FIELD

Embodiments of the present application generally relate to wireless communication technology, especially to a central unit, distributed unit, user equipment and method for application data unit based data transmission.

### BACKGROUND

Extended Reality (XR), including Augmented Reality (AR) and Virtual Reality (VR), as well as Cloud Gaming (CG), presents a new promising category of connected devices, applications, and services. Application and traffic awareness in Radio Access Network (RAN) is one of key feature to improve user experience of XR services. XR services require high bit rate with bounded latency. Typically, the applications require a certain minimum granularity of application data to be available on the client side before the next level of processing can start. This minimum granularity of application data is referred to ‘Application Data Unit’ (ADU).

In NG interface between a base station (BS) and a core network (CN), the ADU related information is probably included in a NG-U header per QoS flow. However, the information in the NG-U header is either removed by a central unit (CU) of the BS or protected by PDCP layer. Therefore, a distributed unit (DU) of the BS cannot be aware of ADU related information per DRB basis after the procedure of QoS flow to DRB mapping.

Further, the NR-U protocol layer is used for flow control of user data packets transferred from the node hosting NR PDCP to the corresponding node. The existing flow control is mainly based on the delivery status of PDCP PDU, which is not applicable to ADU based QoS framework. Moreover, the CU of the BS may provide information of downlink NR PDCP PDUs to be discarded for user data associated with a specific data radio bearer, which is also not applicable to ADU based QoS framework.

### SUMMARY

Some embodiments of the present application provide a central unit (CU) of a network node. The CU includes: a processor and a transceiver coupled to the processor. The processor is configured to: receive, via the transceiver, application data unit (ADU) information related to a plurality of application data units (ADUs) from a core network; determine data radio bearer (DRB) and ADU association information related to one or more of the plurality of ADUs that are associated with one or more data radio bearers (DRBs) to a distributed unit (DU) of the network node over an CU-DU interface; and transmit, via the transceiver, the DRB and ADU association information and the ADU information to the DU over the CU-DU interface.

In some embodiments, the processor is further configured to transmit, via the transceiver, the DRB and ADU association information to the DU via an F1 application protocol (F1-AP) signaling.

In some embodiments, the processor is further configured to transmit, via the transceiver, the ADU information to the DU in a user plane protocol of a packet data convergence protocol (PDCP) protocol data unit (PDU).

In some embodiments, the processor is further configured to add the ADU information in an F1 user plane (F1-U) protocol.

In some embodiments, the F1-U protocol is provided by a GPRS tunneling protocol user plane (GTP-U) extension header, and the F1-U protocol is: added in a new radio (NR) radio access network (RAN) container of the GTP-U extension header; added in a new container of the GTP-U extension header; or added in a packet data unit session container of the GTP-U extension header.

In some embodiments, the processor is further configured to: handle the ADU information before generating PDCP PDUs; and attach the ADU information to the PDCP PDUs.

In some embodiments, the processor is further configured to receive, via the transceiver, ADU based flow control information from the DU.

In some embodiments, the processor is further configured to: transmit, via the transceiver, a DRB identification to the DU; and receive, via the transceiver, the ADU based flow control information from the DU via a DRB corresponding to the DRB identification.

In some embodiments, the ADU based flow control information includes at least one of: one or more ADU sequence numbers of one or more ADUs that were successfully delivered to a user equipment (UE) for user data with the DRB; one or more ADU sequence numbers of one or more ADUs that were not delivered to the UE or not transmitted to a lower layer of the DU; one or more packet sequence numbers that were not delivered to the UE or not transmitted to the lower layer of the DU; or one or more ADU sequence numbers of one or more ADUs that were transmitted to the lower layer of the DU for user data associated with the DRB.

In some embodiments, the processor is further configured to transmit, via the transceiver, an ADU discard indication to the DU.

In some embodiments, the ADU discard indication is included in an F1-U protocol, and includes at least one of: one or more ADUs to be discarded; or an indication of non-critical packet to be discarded, which indicates at least one non-critical packet of the one or more ADUs to be discarded.

In some embodiments, the DRB and ADU association information indicates that at least one packet to be transmitted via the one or more DRBs corresponds to the same ADU or at least one packet of an ADU corresponds to one or more DRBs.

In some embodiments, the ADU information includes at least one of: an ADU sequence number; a packet sequence number of a packet of an ADU; an indication of last packet of a packet of an ADU; or an indication of importance of a packet of an ADU.

Some embodiments of the present application provide a DU of a network node. The DU includes: a processor and a transceiver coupled to the processor. The processor is configured to: receive, via the transceiver, ADU information and DRB and ADU association information from a CU over a CU-DU interface, wherein the ADU information relates to a plurality of ADUs, and the DRB and ADU association information relates to one or more of the plurality of ADUs that are associated with one or more DRBs to the CU of the network node over the CU-DU interface; determine ADU based flow control information according to the ADU information and the DRB and ADU association information; and transmit, via the transceiver, the ADU based flow control information to the CU.

In some embodiments, the processor is further configured to receive, via the transceiver, the DRB and ADU association information from the CU via an F1-AP signaling.

In some embodiments, the processor is further configured to receive, via the transceiver, the ADU information from the CU in a user plane protocol of a PDCP PDU.

In some embodiments, the ADU information is added in an F1-U protocol.

In some embodiments, the F1-U protocol is provided by a GTP-U extension header, and the F1-U protocol is: added in a NR RAN container of the GTP-U extension header; added in a new container of the GTP-U extension header; or added in a packet data unit session container of the GTP-U extension header.

In some embodiments, the processor is further configured to: obtain the ADU information from the GTP-U extension header; add the ADU information in a header of an existing layer or in an ADU layer; and transmit, via the transceiver, the ADU information to a UE.

In some embodiments, the processor is further configured to: receive, via the transceiver, a DRB identification from the CU; and transmit, via the transceiver, the ADU based flow control information to the CU via a DRB corresponding to the DRB identification.

In some embodiments, the ADU based flow control information includes at least one of: one or more ADU sequence numbers of one or more ADUs that were successfully delivered to a user equipment (UE) for user data with the DRB; one or more ADU sequence numbers of one or more ADUs that were not delivered to the UE or not transmitted to a lower layer of the DU; one or more packet sequence numbers that were not delivered to the UE or not transmitted to the lower layer of the DU; or one or more ADU sequence numbers of one or more ADUs that were transmitted to the lower layer of the DU for user data associated with the DRB.

In some embodiments, the processor is further configured to: receive, via the transceiver, an ADU discard indication from the CU; and discard at least one packet related to the one or more ADUs according to the ADU discard indication.

In some embodiments, the discard indication is included in an F1-U protocol, and includes at least one of: one or more ADUs to be discarded; or an indication of non-critical packet to be discarded, which indicates at least one non-critical packet of the one or more ADUs to be discarded.

In some embodiments, the DRB and ADU association information indicates that at least one packet to be transmitted via the one or more DRBs corresponds to the same ADU or at least one packet of an ADU corresponds to one or more DRBs.

In some embodiments, the ADU information includes at least one of: an ADU sequence number; a packet sequence number of a packet of an ADU; an indication of last packet of a packet of an ADU; or an indication of importance of a packet of an ADU.

Some embodiments of the present application provide a UE. The UE includes: a processor and a transceiver coupled to the processor. The processor s configured to: receive, via the transceiver, a network packet from a DU of a network node; and obtain ADU information from a header of an existing layer of the network packet or from an ADU layer of the network packet, or obtain the ADU information from a PDCP PDU of the network packet before parsing the PDCP PDU.

In some embodiments, the ADU information includes at least one of: an ADU sequence number; a packet sequence number of a packet of an ADU; an indication of last packet of a packet of an ADU; or an indication of importance of a packet of an ADU.

Some embodiments of the present application provide a method of a network node. The network node includes a CU and a DU. The method includes: receiving, by the CU, ADU information related to a plurality of ADUs from a core network; determining, by the CU, DRB and ADU association information related to one or more of the plurality of ADUs that are associated with one or more DRBs to the DU of the network node over a CU-DU interface; and transmitting, via the CU, the DRB and ADU association information and an ADU information related to the one or more DRBs to the DU over the CU-DU interface.

In some embodiments, the method further includes: receiving, by the DU, the DRB and ADU association information and the ADU information related to the one or more DRBs from the CU over the CU-DU interface; determining, by the DU, ADU based flow control information according to the ADU information related to the one or more DRBs and the DRB and ADU association information; and transmitting, by the DU, the ADU based flow control information to the CU.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates a block diagram of a wireless communication system in accordance with some embodiments of the present application.

FIG. 3 is a schematic diagram of message transmission between a CU and a DU in accordance with some embodiments of the present application.

FIG. 4 is a schematic diagram of protocol stacks between a UE and a BS including a CU and a DU in accordance with some embodiments of the present application.

FIG. 5 is a schematic diagram of protocol stacks between a UE and a BS including a CU and a DU in accordance with some embodiments of the present application.

FIG. 6 is a schematic diagram of message transmission between a CU and a DU in accordance with some embodiments of the present application.

FIG. 7 is a schematic diagram of message transmission between a CU and a DU in accordance with some embodiments of the present application.

FIG. 8 illustrates a flow chart of a method for wireless communications according to an embodiment of the present disclosure.

FIG. 9A illustrates a block diagram of a CU in accordance with some embodiments of the present application.

FIG. 9B illustrates a block diagram of a DU in accordance with some embodiments of the present application.

FIG. 9C illustrates a block diagram of a UE in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), etc. It is contemplated that along with the 3GPP and related communication technology development, the terminologies recited in the present application may change, which should not affect the principle of the present application.

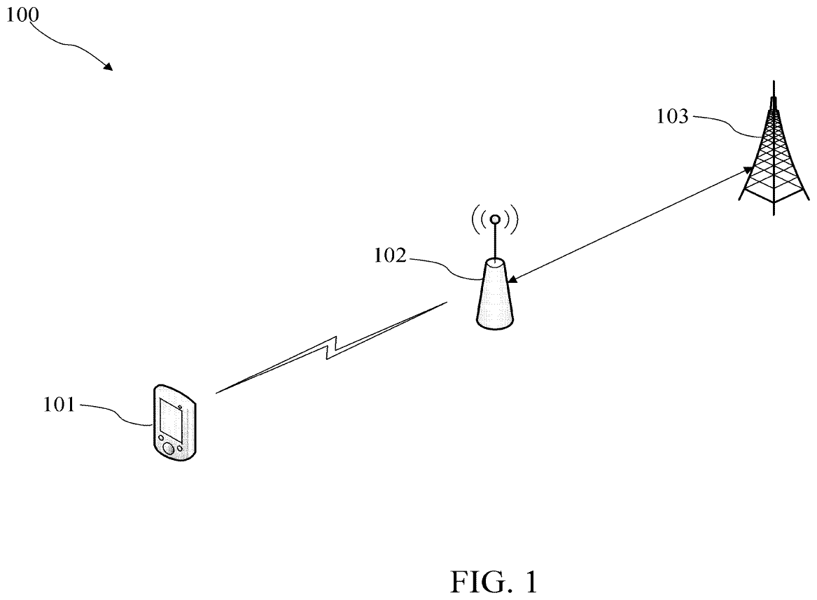

Referring to FIG. 1, a wireless communication system 100 may include a user equipment (UE) 101, a base station (BS) 102 and a core network (CN) 103. Although a specific number of the UE 101, the BS 102 and the CN 103 are depicted in FIG. 1, it is contemplated that any number of the UEs 101, the BSs 102 and the CNs 103 may be included in the wireless communication system 100.

The CN 103 may include a core Access and Mobility management Function (AMF) entity. The BS 102, which may communicate with the CN 103, may operate or work under the control of the AMF entity. The CN 103 may further include a User Plane Function (UPF) entity, which communicatively coupled with the AMF entity.

The BS 102 may be distributed over a geographic region. In certain embodiments of the present application, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally part of a radio access network that may include one or more controllers communicably coupled to one or more corresponding BS(s).

The UE 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, the UE 101 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, the UE 101 may include, for example, but is not limited to, wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 101 may communicate directly with the BS 102 via uplink communication signals.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 3GPP-based network, a 3GPP 5G network, a satellite communications network, a high altitude platform network, and/or other communications networks.

In some embodiments of the present application, the wireless communication system 100 is compatible with the 5G New Radio (NR) of the 3GPP protocol or the 5G NR-light (or reduced capability NR UEs) of the 3GPP protocol, wherein the BS 102 transmits data using an OFDM modulation scheme on the downlink (DL) and the UE 101 transmits data on the uplink (UL) using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, the UE 101 and BS 102 may communicate using other communication protocols, such as the IEEE 802.11 family of wireless communication protocols. Further, in some embodiments of the present application, the UE 101 and BS 102 may communicate over licensed spectrums, whereas in other embodiments, the UE 101 and the BS 102 may communicate over unlicensed spectrums. The present application is not intended to be limited to the implementation of any particular wireless communication system architecture or protocol. In yet some embodiments of present application, the BS 102 may communicate with the UE 101 using the 3GPP 5G protocols.

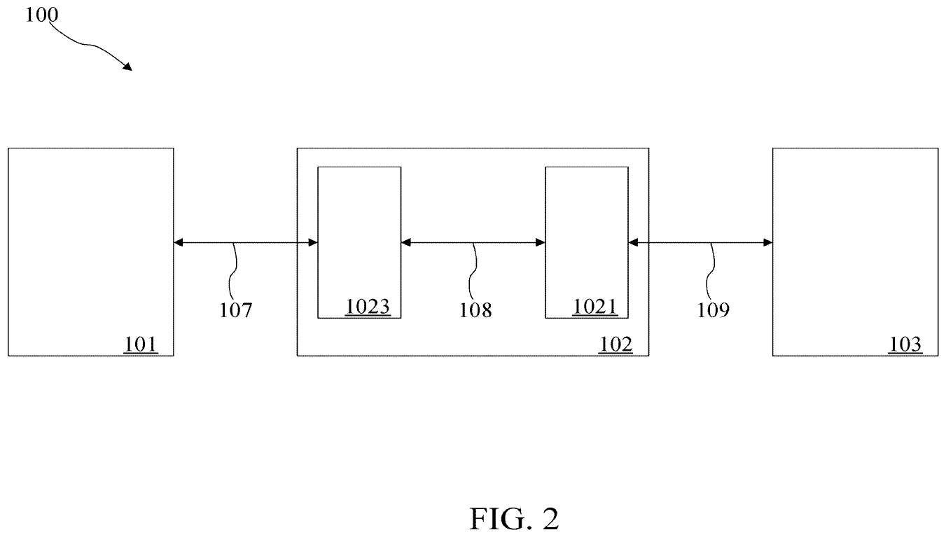

FIG. 2 is a block diagram of the wireless communication system 100 in accordance with some embodiments of the present application. In some embodiments, the BS 102 may include a central unit (CU) 1021 and a distributed unit (DU) 1023. The CU 1021 may communicate with the CN 103 via an interface 109 (e.g., an NG interface), and may communicate with the DU 1023 via a CU-DU interface 108 (e.g., an F1 interface). The DU 1023 may communicate with the CU 1021 via the interface 108, and may communicate with the UE 101 via an interface 107 (e.g., an Uu interface).

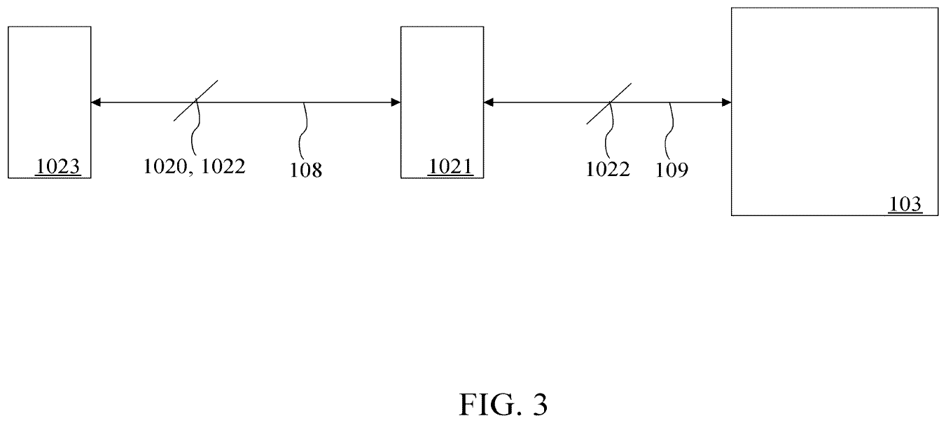

FIG. 3 is a schematic diagram of message transmission of the wireless communication system 100 in accordance with some embodiments of the present application. In some embodiments, the CU 1021 may receive an application data unit (ADU) information 1022 from the CN 103. The ADU information 1022 may relate to a plurality of application data units (ADUs).

In some embodiments, the CU 1021 may determine data radio bearer (DRB) and application data unit (ADU) association information 1020 related to one or more of the plurality of ADUs that are associated with one or more data radio bearers (DRBs) to the DU 1023. The CU 1021 may transmit the DRB and ADU association information 1020 to the DU 1023 over the CU-DU interface 108 between the CU 1021 and the DU 1023. In other words, the DU 1023 may receive the DRB and ADU association information 1020 from the CU 1201 over the CU-DU interface 108. In some embodiments, the DRB and ADU association information 1020 may indicate that: (1) at least one packet to be transmitted via the one or more DRBs corresponds to the same ADU; or (2) at least one packet of an ADU corresponds to one or more DRBs.

For example, the ADU may represent a Groups of pictures (GOPs) for video service. GOPs are grouped together in ways that enhance the visual result of a video sequence. GOPs includes various types such as intra-coded pictures (I-frame), predictive coded pictures (P-frame), B-predictive coded pictures (B-frame). For another example, the ADU may represent I-frame and P-frame, FOV (Field of View) stream and omnidirectional stream, video/depth and pose/control, video stream and audio stream.

In some embodiments, the CU 1021 may transmit the DRB and ADU association information 1020 to the DU 1023 via an F1 application protocol (F1-AP) signaling during a DRB setup related procedure or a DRB modification related procedure. In particular, the F1-AP signaling including the DRB and ADU association information 1020 may be a message of UE CONTEXT SETUP REQUEST (specified in 3GPP TS 38.473) or a message of UE CONTEXT MODIFICATION REQUEST (specified in 3GPP TS 38.473).

For example, the DRB and ADU association information 1020 is provided in a DRB to Be Setup List Information Element (IE) in a DRB to Be Setup List below. Specifically, when a DRB ‘#1’ is to be setup, at least one ADU associated DRB (i.e., a DRB ‘#2’) is also indicated. In other words, the DRB ‘#1’ and the at least one ADU associated DRB (i.e., the DRB ‘#2’) correspond to the same ADU.

```
DRB to Be Setup List
  >DRB to Be Setup Item IEs
    >>DRB ‘#1”
    >>ADU associated DRBs
      >>DRB ‘#2”
```

For another example, the DRB and ADU association information 1020 is provided in a separate IE in an ADU associated DRBs List below. Specifically, the separate IE includes ADU association IDs (i.e., ADU association ID ‘#1” and ‘#2”). In this example, it is indicated that DRB ‘#1’ and DRB ‘#2’ are associated with an ADU with ID ‘#1’, and DRB ‘#3’ and DRB ‘#4’ are associated with an ADU with ID ‘#2’. In other words, the DRB ‘#1’ and the DRB ‘#2’ correspond to the same ADU, and the DRB ‘#3’ and the DRB ‘#4’ correspond to the same ADU.

```
DRB to Be Setup List
  >DRB to Be Setup Item IEs
    >>DRB ‘#1”
ADU associated DRBs List
  >ADU association ‘#1’
    >>DRB ‘#1’
    >>DRB ‘#2’
  >ADU association ‘#2’
    >>DRB ‘#3’
    >>DRB ‘#3’
```

In some embodiments, the CU 1021 may transmit the ADU information 1022 to the DU 1023 over the CU-DU interface 108. The ADU information 1022 may relate to the one or more DRBs to the DU 1023. The ADU information 1022 may include at least one of: (1) an ADU sequence number; (2) a packet sequence number of a packet of an ADU; (3) an indication of last packet of a packet of an ADU; or (4) an indication of importance of a packet of an ADU.

The ADU sequence number may be a sequence number of an ADU. The packet sequence number of the packet of the ADU may be sequence number of each packet within the ADU. The indication of last packet of the packet of the ADU may indicate the last packet of the ADU. The indication of importance of the packet of the ADU may indicate: (a) whether the packet is a critical or non-critical; or (b) an importance level of the packet.

In some embodiments, the CU 1021 may transmit the ADU information 1022 to the DU 1023 in a user plane protocol of each packet data convergence protocol (PDCP) protocol data unit (PDU), and the CU may add the ADU information 1022 in an F1-U protocol. The F1-U protocol may be provided by a GPRS tunneling protocol user plane (GTP-U) extension header.

In some implementations, the F1-U protocol may be added in a NR radio access network (RAN) container of the GTP-U extension header (specified in 3GPP TS 38.425). The ADU information 1022 may be added after procedure of QoS flow to DRB mapping and PDCP layer processing. In other words, the ADU information 1022 may be added for each PDCP PDU.

A new frame format may be introduced over NR user plane protocol which carries the ADU information 1022 for each packet. For example, the new frame format USER DATA WITH ADU INFORMATION below is introduced over NR user plane protocol which carries the ADU information 1022 for each packet.

| | | | | | | | | Number |
|---|---|---|---|---|---|---|---|---|
| Bits | | | | | | | | of |
| 7 | 6 | 5 | 4 | 3 | 2 | 1 | 0 | Octets |

| | | | | | |
|---|---|---|---|---|---|
| PDU Type = 4 | Spare | Spare | Spare | ADU | 1 |

information

| | |
|---|---|
| ADU sequence number | 1 |
| packet sequence number within ADU | 0 or 1 |
| indication of last packet within ADU | 0 or 1 |
| indication of importance of packet | 0 or 1 |
| padding | 0 to 3 |

In some implementations, the F1-U protocol may be added in a new container of the GTP-U extension header. In some implementations, the F1-U protocol may be added in a PDU session container of the GTP-U extension header (specified in 3GPP TS 38.415).

In some embodiments, the DU 1023 may obtain the ADU information 1022 from the GTP-U extension header. The DU 1023 may add the ADU information 1022 in: (1) a header of existing layer 2 layer (e.g., PDCP layer, RLC layer and MAC layer); or (2) in a new layer 2 layer, which may be an ADU layer. The DU 1023 may transmit the ADU information 1022 to the UE 101 based on the header of existing layer 2 layer or the new layer 2 layer. The UE 101 may receive a network packet from the DU 1023 and obtain the ADU information 1022 from the header of the existing layer 2 layer of the network packet or from the ADU layer of the network packet.

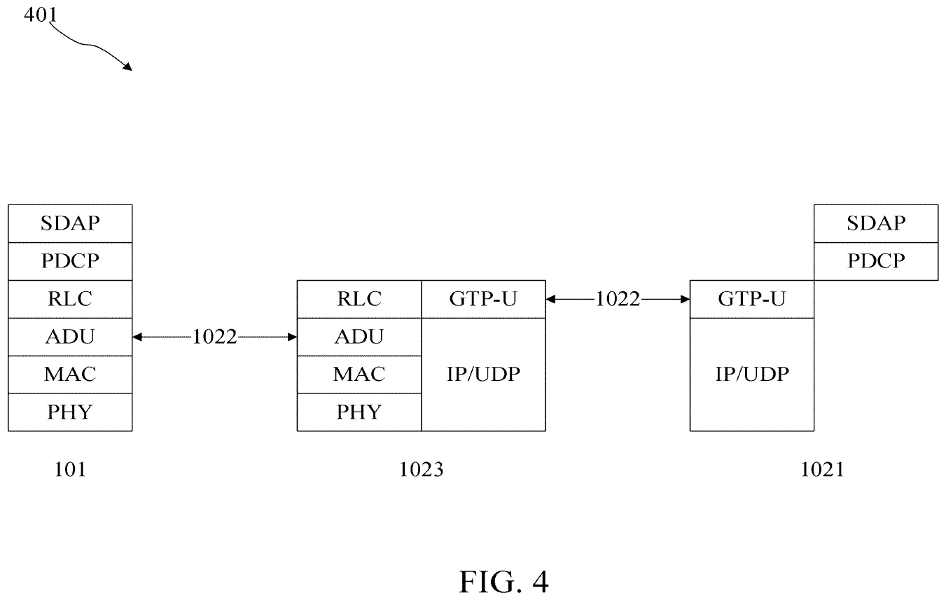

For example, when the DU 1023 add the ADU information 1022 in the new layer 2 layer (i.e., an ADU layer), protocol stacks 401 between the UE 101 and the BS 102 (including the CU 1021 and the DU 1023) is specified in FIG. 4. In this example, the ADU layer is between RLC layer and MAC layer. The ADU information 1022 is transmitted between the CU 1021 and the DU 1023 based on GTP-U layer. The ADU information 1022 is transmitted between the DU 1023 and the UE 101 based on the ADU layer.

In some embodiments, the CU 1021 may handle the ADU information 1022 before generating PDCP PDUs, and may attach the ADU information 1022 to the PDCP PDUs. The UE 101 may obtain the ADU information 1028 from the PDCP PDU of the network packet before processing the PDCP PDU.

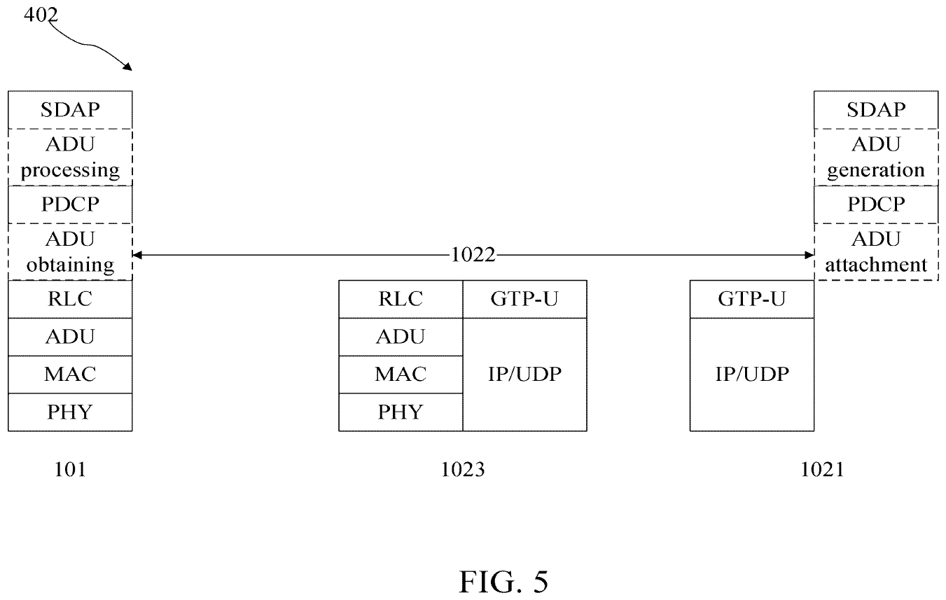

For example, based on protocol stacks 402 specified in FIG. 5, the CU 1021 generates the ADU information 1022 after SDAP layer processing and before PDCP layer processing. Then, the CU 1021 attaches the ADU information 1022 to the PDCP PDUs. After packet transmission between the CU 1021 and the DU 1023, the UE 101 obtains the ADU information 1022 before PDCP layer processing. Then, the UE 101 processes the ADU information 1022 after PDCP layer processing and before SDAP layer processing.

In some embodiments, after transmission of the DRB and ADU association information 1020 and the ADU information 1022, the CU 1021 or the DU 1023 may perform an ADU based flow control according to the DRB and ADU association information 1202 and the ADU information 1022.

In some embodiments, because packets of ADU(s) may be served by multiple DRBs between the CU 1021 and the DU 1023, ADU based flow control information related to the ADU based flow control may be provided via one of F1-U protocols (i.e., GTP-U tunnels) of the DRBs. In particular, the CU 1021 may select one of F1-U protocols of the DRBs for providing the ADU based flow control information so that the DU 1023 may generate and provide the ADU based flow control information to the CU 1021 based on the selected one of F1-U protocols of the DRBs.

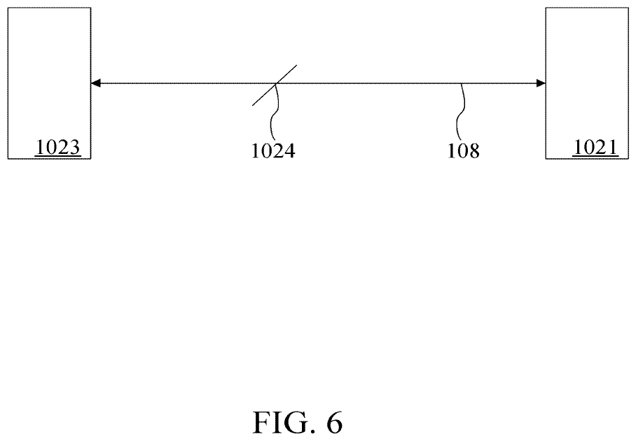

FIG. 6 is a schematic diagram of message transmission between the CU 1021 and the DU 1023 in accordance with some embodiments of the present application. In some embodiments, the CU 1021 may select a specific DRB from the DRBs between the CU 1021 and the DU 1023 for the DU 1023 to provide the ADU based flow control information. The CU 1021 may transmit a DRB identification 1024 of the specific DRB to the DU 1023 so that the DU 1023 may generate and provide the ADU based flow control information via the specific DRB.

In some embodiments, the ADU based flow control information may be carried in the user plane protocol of the specific DRB (e.g., in the GTP-U extension header of specific DRB), and include at least one of: (1) information of one or more ADUs that were successfully delivered to the UE 101; (2) information of one or more ADUs that were transmitted to the lower layer of the DU 1023; (3) information of one or more ADUs that were not delivered to the UE 101; or (4) information of one or more ADUs that were not transmitted to the lower layer of the DU 1023.

For example, the information of one or more ADUs that were successfully delivered to the UE 101 may include one or more ADU sequence numbers of one or more ADUs that were successfully delivered to the UE 101 for user data with the DRB. The information of one or more ADUs that were transmitted to the lower layer of the DU 1023 may include one or more ADU sequence numbers of one or more ADUs that were not delivered to the UE or not transmitted to a lower layer of the DU. The information of one or more ADUs that were not delivered to the UE 101 may include one or more packet sequence numbers that were not delivered to the UE or not transmitted to the lower layer of the DU. The information of one or more ADUs that were not transmitted to the lower layer of the DU 1023 may include one or more ADU sequence numbers of one or more ADUs that were transmitted to the lower layer of the DU for user data associated with the DRB.

FIG. 6 is a schematic diagram of message transmission between the CU 1021 and the DU 1023 in accordance with some embodiments of the present application. In some embodiments, when an IP packet belonging to one particular ADU is too late (i.e., the queue time of the IP packet exceeds a threshold), the CU 1021 may transmit an ADU discard indication 1026 to the DU 1023. The DU 1023 may perform ADU discard according to the ADU discard indication 1026.

In particular, the ADU discard indication 1026 may be included in an F1-U protocol, and may include at least one of: (1) one or more ADUs to be discarded; or (2) an indication of non-critical packet to be discarded, which indicates at least one non-critical packet of the one or more ADUs to be discarded. When receives the ADU discard indication 1026, the DU 1023 may discard all buffered or available packets of all associated DRBs of the ADU indicated by the sequence number or the DU 1023 may discard all packets of the ADU that marked as non-critical according to the indication of non-critical packets to be discarded. For example, a new frame format USER DATA WITH ADU INFORMATION below is introduced over NR user plane protocol which carries the ADU information 1022 for each packet.

| | | | | | | | | Number |
|---|---|---|---|---|---|---|---|---|
| Bits | | | | | | | | of |
| 7 | 6 | 5 | 4 | 3 | 2 | 1 | 0 | Octets |

| | | | | | |
|---|---|---|---|---|---|
| PDU Type = 2 | Spare | Spare | ADU | ADU | 1 |

| | |
|---|---|
| discard | information |

| | |
|---|---|
| NR-U sequence number | 3 |
| ADU sequence number | 0 or 1 |
| the number of packets of the ADU | 0 or 1 |
| packet sequence number | 0 or 1 |
| indication of importance of packet | 0 or 1 |
| discard ADU sequence | 0 to 3 |
| padding | 0 to 3 |

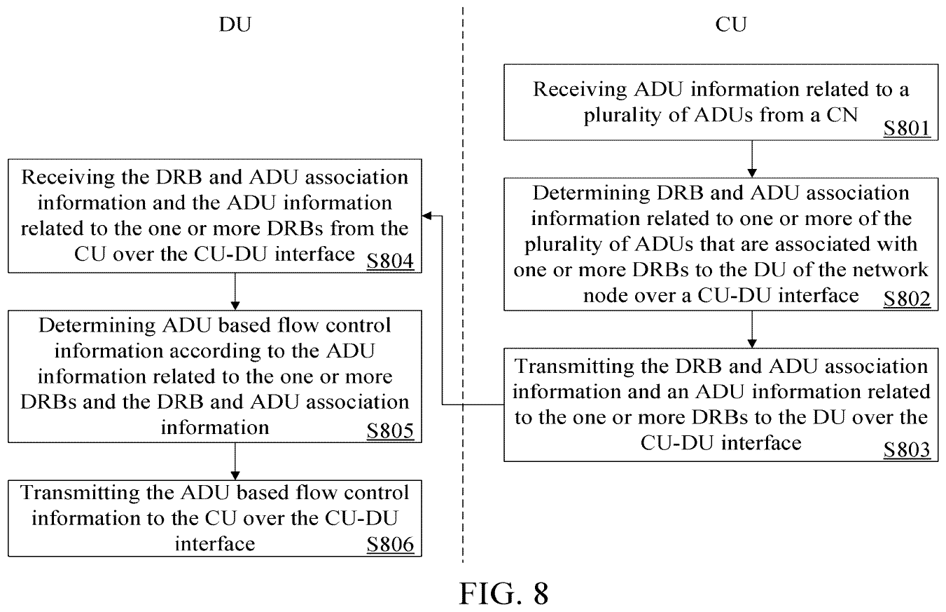

FIG. 8 illustrates a flow chart of a method for wireless communications in accordance with some embodiments of the present application. Referring to FIG. 8, method 800 is performed by a CU and a DU of a network node (e.g., the CU 1021 and the DU 1023 of the BS 102) in some embodiments of the present application.

In some embodiments, operation S801 is executed to receive, by the CU, ADU information related to a plurality of ADUs from a core network. Operation S802 is executed to determine, by the CU, DRB and ADU association information related to one or more of the plurality of ADUs that are associated with one or more DRBs to the DU of the network node over a CU-DU interface. Operation S803 is executed to transmit, via the CU, the DRB and ADU association information and an ADU information related to the one or more DRBs to the DU over the CU-DU interface.

Operation S804 is executed to receive, by the DU, the DRB and ADU association information and the ADU information related to the one or more DRBs from the CU over the CU-DU interface. Operation S805 is executed to determine, by the DU, ADU based flow control information according to the ADU information related to the one or more DRBs and the DRB and ADU association information. Operation S806 is executed to transmit, by the DU, the ADU based flow control information to the CU over the CU-DU interface.

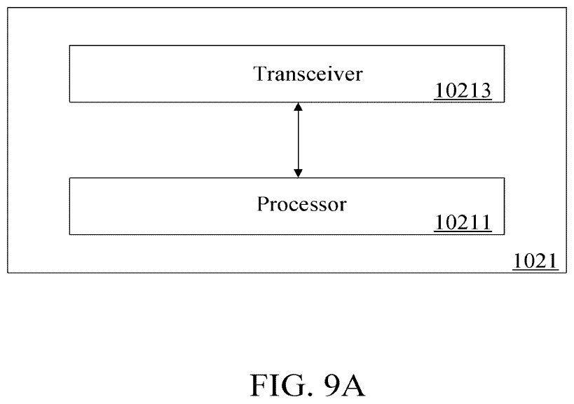

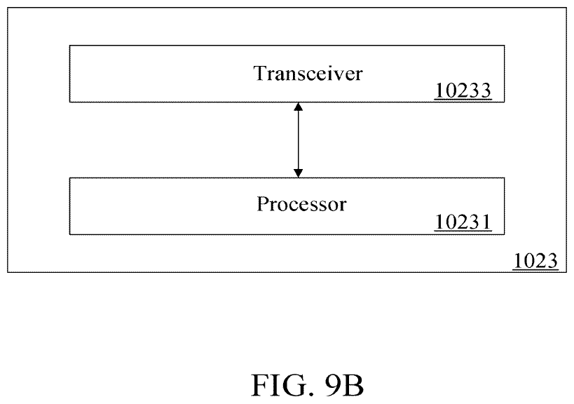

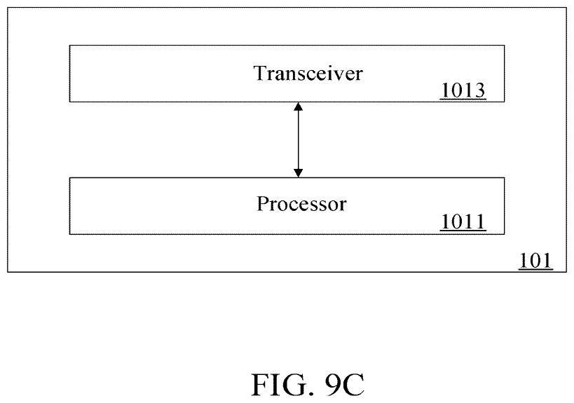

FIGS. 9A to 9C illustrate example block diagrams of the CU 1021, the DU 1023 and the UE 101 according to some embodiments of the present disclosure.

As shown in FIG. 9A, the CU 1021 may include at least one non-transitory computer-readable medium (not illustrated in FIG. 9A), a processor 10211 and a transceiver 10213. The processor 10211 may be electrically coupled to the non-transitory computer-readable medium (not illustrated in FIG. 9A) and the transceiver 10213.

Although in this figure, elements such as processor 10211 and transceiver 10213 are described in the singular, the plural is contemplated unless limitation to the singular is explicitly stated. In certain embodiments of the present disclosure, the CU 1021 may further include an input device, a memory, and/or other components.

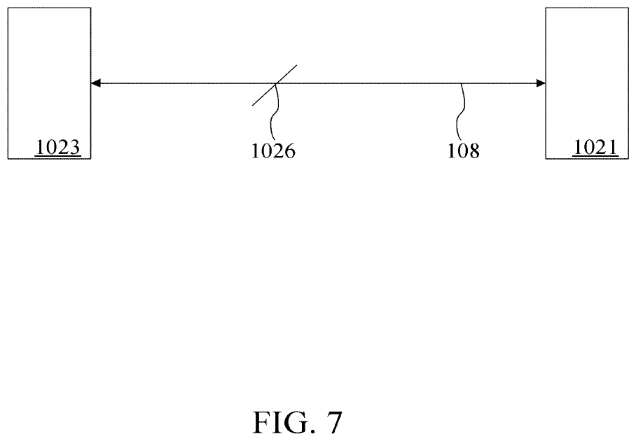

In some embodiments of the present disclosure, the non-transitory computer-readable medium may have stored thereon computer-executable instructions to cause a processor to implement the procedure with respect to the CU 1021 as described above. For example, the computer-executable instructions, when executed, cause the processor 10211 interacting with transceiver 10213, so as to perform the operations with respect to the CU 1021 depicted in FIGS. 2 to 8.

As shown in FIG. 9B, the DU 1023 may include at least one non-transitory computer-readable medium (not illustrated in FIG. 9B), a processor 10231 and a transceiver 10233. The processor 10231 may be electrically coupled to the non-transitory computer-readable medium (not illustrated in FIG. 9B) and the transceiver 10233.

Although in this figure, elements such as processor 10231 and transceiver 10233 are described in the singular, the plural is contemplated unless limitation to the singular is explicitly stated. In certain embodiments of the present disclosure, the DU 1023 may further include an input device, a memory, and/or other components.

In some embodiments of the present disclosure, the non-transitory computer-readable medium may have stored thereon computer-executable instructions to cause a processor to implement the procedure with respect to the DU 1023 as described above. For example, the computer-executable instructions, when executed, cause the processor 10231 interacting with transceiver 10233, so as to perform the operations with respect to the DU 1023 depicted in FIGS. 2 to 8.

As shown in FIG. 9C, the UE 101 may include at least one non-transitory computer-readable medium (not illustrated in FIG. 9C), a processor 1011 and a transceiver 1013. The processor 1011 may be electrically coupled to the non-transitory computer-readable medium (not illustrated in FIG. 9C) and the transceiver 1013.

Although in this figure, elements such as processor 1011 and transceiver 1013 are described in the singular, the plural is contemplated unless limitation to the singular is explicitly stated. In certain embodiments of the present disclosure, the UE 101 may further include an input device, a memory, and/or other components.

In some embodiments of the present disclosure, the non-transitory computer-readable medium may have stored thereon computer-executable instructions to cause a processor to implement the procedure with respect to the UE 101 as described above. For example, the computer-executable instructions, when executed, cause the processor 1011 interacting with transceiver 1013, so as to perform the operations with respect to the UE 101 depicted in FIGS. 1, 2, 4 and 5.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. A central unit (CU) of a network node, comprising:
at least one memory; and
at least one processor coupled with the at least one memory and configured to cause the CU to:
receive application data unit (ADU) information related to a plurality of application data units (ADUs) from a core network;
determine data radio bearer (DRB) and ADU association information related to one or more of the plurality of ADUs that are associated with one or more data radio bearers (DRBs) to a distributed unit (DU) of the network node over a CU-DU interface; and
transmit the DRB and ADU association information and an ADU information related to the one or more DRBs to the DU over the CU-DU interface.

2. The CU of claim 1, wherein the at least one processor is further configured to cause the CU to transmit the DRB and ADU association information to the DU via an F1 application protocol (F1-AP) signaling.

3. The CU of claim 1, wherein the at least one processor is further configured to cause the CU to transmit the ADU information related to the one or more DRBs to the DU in a user plane protocol of a packet data convergence protocol (PDCP) protocol data unit (PDU).

4. The CU of claim 1, wherein the at least one processor is further configured to cause the CU to:
receive ADU based flow control information from the DU.

5. The CU of claim 4, wherein the at least one processor is further configured to cause the CU to:
transmit a DRB identification to the DU; and
receive the ADU based flow control information from the DU via a DRB corresponding to the DRB identification.

6. The CU of claim 1, wherein the at least one processor is further configured to cause the CU to:
transmit an ADU discard indication to the DU according to the ADU information related to the one or more DRBs.

7. The CU of claim 1, wherein the DRB and ADU association information indicates that at least one packet to be transmitted via the one or more DRBs corresponds to a same ADU or at least one packet of an ADU corresponds to one or more DRBs.

8. A distributed unit (DU) of a network node, comprising:
at least one memory; and
at least one processor coupled with the at least one memory and configured to cause the DU to:
receive data radio bearer (DRB) and application data unit (ADU) association information and an ADU information from a central unit (CU) over a CU-DU interface, wherein the DRB and ADU association information relates to one or more of a plurality of ADUs that are associated with one or more data radio bearers (DRBs) to the CU of the network node over the CU-DU interface, and the ADU information relates to the one or more DRBs to the CU;
determine ADU based flow control information according to the ADU information related to the one or more DRBs and the DRB and ADU association information; and
transmit the ADU based flow control information to the CU.

9. The DU of claim 8, wherein the at least one processor is further configured to cause the DU to receive the DRB and ADU association information from the CU via an F1 application protocol (F1-AP) signaling.

10. The DU of claim 8, wherein the at least one processor is further configured to cause the DU to receive the ADU information related to the one or more DRBs from the CU in a user plane protocol of a packet data convergence protocol (PDCP) protocol data unit (PDU).

11. The DU of claim 8, wherein the at least one processor is further configured to cause the DU to:
receive a DRB identification from the CU; and
transmit the ADU based flow control information to the CU via a DRB corresponding to the DRB identification.

12. The DU of claim 8, wherein the at least one processor is further configured to cause the DU to:
receive an ADU discard indication from the CU; and
discard at least one packet related to the one or more ADUs according to the ADU discard indication.

13. The DU of claim 12, wherein the ADU discard indication is included in a F1 user plane (F1-U) protocol, and includes at least one of:
one or more ADUs to be discarded; or
an indication of non-critical packets to be discarded, which indicates at least one non-critical packet of the ADU to be discarded.

14. A user equipment (UE), comprising:
at least one memory; and
at least one processor coupled with the at least one memory and configured to cause the UE to:
receive a packet of a data radio bearer (DRB) from a network node; and
obtain application data unit (ADU) information from a header of an existing layer of the packet of the DRB or from an ADU layer of the packet of the DRB, or obtain the ADU information from a header of packet data convergence protocol (PDCP) packet data unit (PDU) of the network packet before processing the PDCP PDU.

15. The UE of claim 14, wherein the ADU information includes at least one of:
an ADU sequence number;
a packet sequence number of a packet of an ADU;
an indication of last packet of a packet of an ADU; or
an indication of importance of a packet of an ADU.

16. The UE of claim 14, wherein the existing layer comprises a layer 2 layer of the packet.

17. The UE of claim 14, wherein the ADU layer comprises a layer 2 layer.

18. The processor for wireless communication, comprising:
at least one controller coupled with at least one memory and configured to cause the processor to:
receive a packet of a data radio bearer (DRB) from a network node; and
obtain application data unit (ADU) information from a header of an existing layer of the packet of the DRB or from an ADU layer of the packet of the DRB, or obtain the ADU information from a header of packet data convergence protocol (PDCP) packet data unit (PDU) of the network packet before processing the PDCP PDU.

19. The processor of claim 18, wherein the ADU information includes at least one of:
an ADU sequence number;
a packet sequence number of a packet of an ADU;
an indication of last packet of a packet of an ADU; or
an indication of importance of a packet of an ADU.

20. The processor of claim 18, wherein the existing layer comprises a layer 2 layer of the packet.
